(19) United States
(12) Patent Application Publication
(10) Pub. No.: US 2016/0078414 A1
(43) Pub. Date: Mar. 17, 2016

(54) SOLID WASTE IDENTIFICATION AND SEGREGATION SYSTEM

(71) Applicant: ECOWASTEHUB CORP., Dayton, OH (US)

(72) Inventors: Heena Rathore, Springboro, OH (US); Rakesh Rathore, Springboro, OH (US)

(21) Appl. No.: 14/888,752

(22) PCT Filed: May 2, 2014
(86) PCT No.: PCT/US14/36535

§ 371 Date: Nov. 3, 2015

Related U.S. Application Data
(60) Provisional application No. 61/819,004, filed on May 3, 2013.
(60) Provisional application No. 61/927,023, filed on Jan. 14, 2014.

(51) Int. Cl. G06Q 10/00; B65F 1/00; G06K 9/62

(52) U.S. Cl. CPC G06Q 10/30; G06K 9/6255; G06K 9/6267; B65F 1/0053; G06K 2017/0054

(57) ABSTRACT

A method and system provide support for instructing a user as to an appropriate solid waste receptacle to discard a solid waste item into based on identification of the solid waste item. An image of the solid waste item is captured prior to being discarded in a solid waste receptacle. The solid waste item is classified into a solid waste item type based on the captured image of the solid waste item. The solid waste item type is associated with a recommended disposition method to dispose of the solid waste item. The user is instructed to discard the solid waste item into the appropriate solid waste receptacle based on the recommended disposition method of the solid waste item.

### CROSS-REFERENCE TO RELATED APPLICATIONS

This application claims the benefit of U.S. Application No. 61/819,004 filed on May 3, 2013, which is incorporated herein by reference in its entirety. This application also claims the benefit of U.S. Application No. 61/927,023 filed on Jan. 14, 2014, which is incorporated herein by reference in its entirety.

### FIELD OF THE INVENTION

The invention is generally related to solid waste disposal, and in particular to systems and methods utilized therein.

### BACKGROUND OF THE INVENTION

Solid waste items are any discarded materials that are abandoned and/or considered waste-like. Solid waste items can include any type of solid, liquid, semi-solid and/or gaseous materials. Solid waste items also consist of items that are used and then discarded for disposition via landfill, recycling, and/or compost. In 2010, Americans generated approximately 250 million tons of solid waste. 85 million tons of the 250 million tons were committed to disposition via recycling and/or compost. The average American recycles and/or composts 1.51 pounds of an average total of 4.43 pounds of waste generation per day.

A substantial proportion of the generated solid waste is generated by the food service industry, including restaurants as well as other businesses such as hospitals that include cafeterias. Conventionally, such businesses attempt to implement recycling and/or compost programs for solid waste items. Conventionally, such businesses position individual solid waste receptacles so that each individual solid waste receptacle is designated for each type of disposition method. For example, a landfill solid waste receptacle is designated for solid waste items that require a landfill for disposition, a recycling solid waste receptacle is designated for solid waste items that require a recycling plant for disposition, and a composting solid waste receptacle is designated for solid waste items that require a compost center for disposition. Conventionally, such businesses label each individual solid waste receptacle to indicate which solid waste items should be distributed in each individual solid waste receptacle.

In many instances, many of the individuals who dispose of solid waste items at businesses fail to pay adequate attention to the labels located on each solid waste receptacle positioned at each business, and discard the solid waste items into solid waste receptacles with little or no attention as to whether the solid waste items are being placed in the proper solid waste receptacles. For example, some individuals may improperly discard plastic tableware in the solid waste receptacle labeled for compost disposition.

A need therefore continues to exist in the art for an improved manner of reducing improper disposal of solid waste items into solid waste receptacles.

### SUMMARY OF THE INVENTION

The invention addresses these and other problems associated with the prior art by providing a method and system that recommend to a user an appropriate solid waste receptacle for disposal of a solid waste item. Solid waste items are any discarded materials that are abandoned and/or considered waste-like. Solid waste items can include any type of solid, liquid, semi-solid and/or gaseous materials. In many embodiments consistent with the invention, an image of a solid waste item is captured prior to the solid waste item being discarded in a solid waste receptacle. The captured image is then compared with stored images in a database to determine in which solid waste receptacle the solid waste item should be discarded. Doing so may adequately instruct the user as to which solid waste receptacle to discard the solid waste item.

Therefore, consistent with one aspect of the invention, a system includes an image detection system that is configured to capture an image of a solid waste item prior to the solid waste item being discarded in a solid waste receptacle. A processor is configured to classify the solid waste item into a solid waste item type based on the captured image of the solid waste item. The solid waste item is associated with a recommended disposition method to dispose of the solid waste item. The processor is configured to instruct the user to discard the solid waste item into the appropriate solid waste receptacle based on the solid waste item type of the solid waste item. The appropriate solid waste receptacle is designated based on the recommended disposition method of the solid waste item.

Further features and advantages of the invention, as well as the structure and operation of various embodiments of the invention, are described in detail below with reference to the accompanying drawings. The invention is not limited to the specific embodiments described herein. The embodiments are presented for illustrative purposes only and so that readers will have multiple views enabling better perception of the invention, which is broader than any particular embodiment. Additional embodiments will be apparent to persons skilled in the relevant art(s) based on the teachings set forth in this patent document.

### BRIEF DESCRIPTION OF THE DRAWINGS

The accompanying drawings, which are incorporated herein and form part of the specification, illustrate the present invention and, together with the description, further serve to explain the principles of the present invention and to enable a person skilled in the pertinent art to make and use the present invention. Various embodiments of the present invention are described below with reference to the drawings, wherein like reference numerals are used to refer to like elements throughout.

FIG. 1 is a block diagram of an exemplary automated system for instructing a user as to an appropriate solid waste receptacle for discarding a solid waste item, in accordance with embodiments of the present invention.

FIG. 2 shows a flow chart illustrating a method for instructing a user as to an appropriate solid waste receptacle to discard a solid waste item into, in accordance with embodiments of the present invention.

FIG. 3 is a block diagram of an exemplary automated system for discarding a solid waste item into an appropriate solid waste receptacle, in accordance with embodiments of the present invention.

### DETAILED DESCRIPTION

Embodiments consistent with the invention facilitate operation of a system to instruct a user as to an appropriate solid waste receptacle to discard a solid waste item based on an identification of the solid waste item, rather than simply relying on the user to determine the appropriate solid waste receptacle in which to discard the solid waste item. Alternate embodiments, consistent with the invention facilitate operation of a system to discard a solid waste item into an appropriate solid waste receptacle based on an identification of the solid waste item, rather than simply relying on the user to discard the solid waste item into the appropriate solid waste receptacle.

In particular, traditionally an assumption has been made that each individual is competent to properly dispose of solid waste items into the appropriate solid waste receptacles. Solid waste items are any discarded materials that are abandoned and/or considered waste-like. Solid waste items can include any type of solid, liquid, semi-solid and/or gaseous materials. Conventionally, businesses that generate solid waste that results from the consumption of food, such as restaurants and other business that include cafeterias, have an opportunity to participate in recycling and/or compostable programs. The recycling and/or compostable programs provide a financial and/or environmental incentive to participating businesses to separate their solid waste items on-site at the business. Disposition facilities have found that it is more efficient to have the solid waste items properly separated on-site at the business when the solid waste items are initially discarded rather than having the disposition facilities separate solid waste items after the solid waste items have been mixed together. As a result, businesses are encouraged to properly separate the solid waste items on-site when the solid waste items are initially discarded.

Participating businesses position individual solid waste receptacles so that each solid waste receptacle is designated for a disposition method. For example, a landfill solid waste receptacle is designated for solid waste items that require a landfill for disposition, a recycling solid waste receptacle is designated for solid waste items that require a recycling plant for disposition, and a composting solid waste receptacle is designated for solid waste items that require a compost center for disposition. Conventionally, such businesses label each individual solid waste receptacle to indicate which solid waste items should be distributed in each individual solid waste receptacle and rely on the individuals discarding the solid waste items to properly discard each solid waste item in its appropriate solid waste item receptacle.

The assumption that each individual is competent to properly ascertain the appropriate disposition method for each solid waste item and then to discard each solid waste item into the appropriate solid waste receptacle associated with the appropriate disposition method has had a negative impact on the businesses that provide the solid waste receptacles. In many instances, many of the individuals who dispose of solid waste items at businesses fail to pay adequate attention to the labels located on each solid waste receptacle positioned at each business, and discard the solid waste items into solid waste receptacles with little or no attention as to whether the solid waste items are being placed in the proper solid waste receptacles.

It has been found that business that have been affected by the contamination of solid waste have suffered an unnecessary increase in cost in disposition of solid waste items due to the additional labor required for disposition facilities to sort through the contaminated solid waste to remove the improper solid waste items. Further, the businesses may also forfeit financial benefits from the contaminated disposed product.

Conventionally, disposition facilities are required to sort through the solid waste items improperly discarded into solid waste receptacles after receiving the solid waste items from the businesses that housed the solid waste receptacles. For example, disposition facilities cannot risk contaminating compost with solid waste items that are not capable of being processed into compost. Each disposition facility that receives the solid waste items improperly discarded into the solid waste receptacles has contamination of the disposed product. Thus, the disposition facilities are forced to devote additional labor resources to sort through the contaminated waste increasing the cost of disposition for the businesses and/or forfeiture of financial benefits for the businesses that participate in recycling and/or composting programs.

Businesses struggle to adequately educate and/or motivate individuals who discard of solid waste items into the solid waste receptacles located at the businesses to ensure that the individuals properly discard each solid waste item into appropriate solid waste receptacles. Whether individuals intentionally or accidentally discard solid waste items in incorrect solid waste receptacles, businesses and/or disposition facilities suffer the consequences.

In contrast with conventional approaches, embodiments consistent with the invention decrease the reliance on the individual to properly discard each solid waste item into the appropriate solid waste receptacle to prevent contamination. In some embodiments, the individual is instructed as to the appropriate solid waste receptacle to discard the solid waste item. In other embodiments, the solid waste item is discarded into the appropriate solid waste receptacle for the user.

In some embodiments, each solid waste item is identified and then each solid waste item is classified into a disposition method. For example, each solid waste item is classified as having a landfill disposition method, a recycling disposition method, and/or a composting disposition method. After each solid waste item has been classified with a disposition method, the individual may be instructed as to which solid waste receptacle to discard each solid waste item in some embodiments. In other embodiments each solid waste item may be discarded into the appropriate solid waste receptacle for the user.

In some embodiments, an image detection system may capture an image of each solid waste item prior to being discarded in a solid waste receptacle. A solid waste item database may include a plurality of stored solid waste item images where each stored solid waste item image depicts a solid waste item. The solid waste item database may also include a solid waste item type that is associated with each stored solid waste item image. The solid waste item type may denote a recommended disposition method for the stored solid waste item image. For example, a stored solid waste item image of a banana peel included in the solid waste item database also includes a solid waste item type of a recommended compost disposition method associated with the stored solid waste item image of the banana peel so the banana can be disposed of via the compost disposition method.

A solid waste item computing device may search the solid waste item database for a stored solid waste item image that is substantially similar to the image of the solid waste item captured by the image detection system. For example, the solid waste item computing device searches the solid waste item database for a stored solid waste image of a banana peel that is substantially similar to the image of the banana peel captured by the image detection system.

The solid waste item computing device may search for the solid waste item type associated with the stored solid waste item image that is substantially similar to the image of the solid waste item. If the solid waste item is matched with a stored solid waste image stored in the solid waste item database that is substantially similar to the solid waste item, then the solid waste item type associated with the stored solid waste item image is likely the solid waste item type that should be associated with the solid waste item. For example, the solid waste item computing device may search the solid waste item database for a stored solid waste item image that is substantially similar to the banana peel. The solid waste item type associated with the stored solid waste item image in the solid waste item database is the composting disposition method. The solid waste item computing device then classifies the banana peel that is sought to be disposed of by the user with the solid waste item type of the composting disposition method.

In some embodiments, the solid waste item computing device may then instruct the user to discard the solid waste item into the appropriate solid waste receptacle based on the solid waste item type of the solid waste item. For example, the solid waste item computing device may instruct the user to discard the banana peel into the composting disposition receptacle based on the solid waste item type of the composting disposition method derived from the solid waste item database. In other embodiments, the solid waste computing device may then instruct a robotic arm to discard the solid waste item into the appropriate solid waste receptacle based on the solid waste item type of the solid waste item. For example, the solid waste item computing device may instruct the robotic arm to discard the banana peel into the composting disposition receptacle based on the solid waste item type of the composition disposition method.

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In addition, functionality associated with the various embodiments disclosed herein may be described in terms of being implemented in modules. A module, in this regard, may include hardware, software, firmware or a combination thereof implementing the described functionality. Software may include one or more applications and an operating system. Hardware can include, but may not be limited to, a processor, memory, and/or graphical user display. A module may be any type of processing (or computing device) having one or more processors. For example, a module can be an individual processor, workstation, mobile device, computer, cluster of computers, set-top box, game console or other device having at least one processor. Moreover, it will be appreciated that the functionality of a module may be implemented by multiple modules in some embodiments, and that the functionality of multiple modules may be combined into a common module in some embodiments. Therefore, the invention is not limited to the particular organization of modules described herein.

### Manual Binning of Solid Waste Items

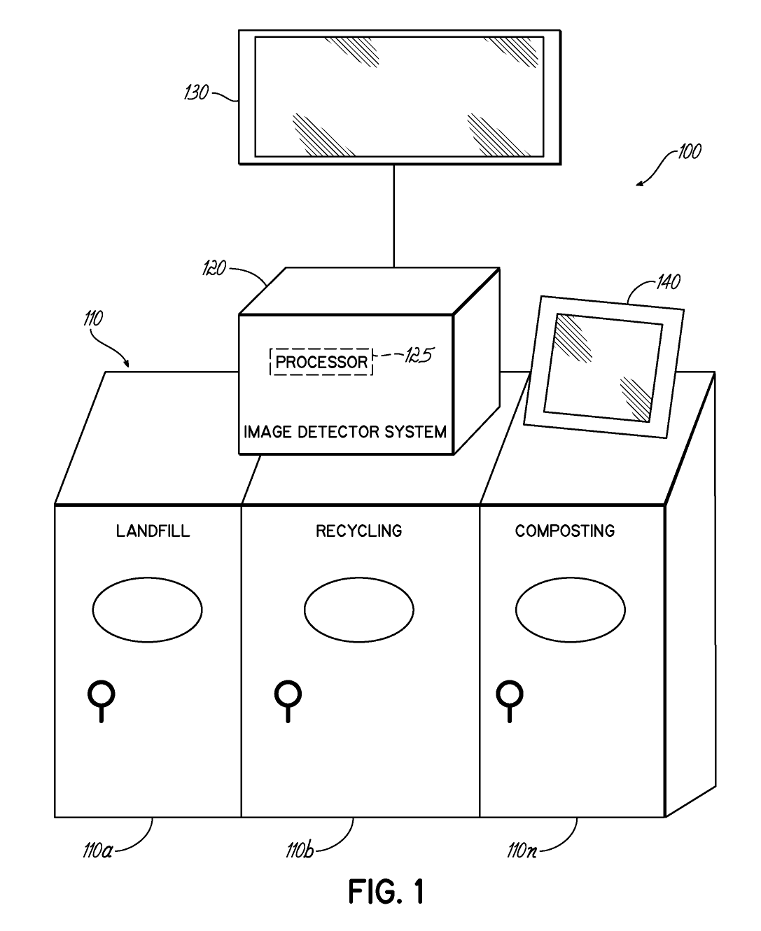

Turning now to FIG. 1, this figure illustrates a solid waste identification system 100 where a solid waste item is identified and then the appropriate solid waste receptacle in which to dispose of the solid waste item is communicated by solid waste identification system 100. Solid waste identification system 100 includes a solid waste receptacle configuration 110, an image detector system 120, a processor 125, a first display 140 and a second display 130. Solid waste receptacle configuration 110 includes a first solid waste receptacle 110a, a second solid waste receptacle 110b, and a third solid waste receptacle 110n where n is an integer greater than or equal to 1. Solid waste identification system 100 depicts an example implementation of solid waste receptacle configuration 110 and the types of solid waste receptacles that a solid waste configuration may include. As would be appreciated by one having skill in the relevant art(s), given the description herein, without departing from the spirit of embodiments herein, other examples of solid waste configurations may include additional combinations of solid waste receptacles not referenced in FIG. 1 to obtain the capabilities of the solid waste receptacle configuration explained in detail below regarding solid waste identification system 100. For example, some embodiments may include multiple solid waste receptacles for different types of recyclable solid waste items (e.g., aluminum, glass, plastic and/or paper products).

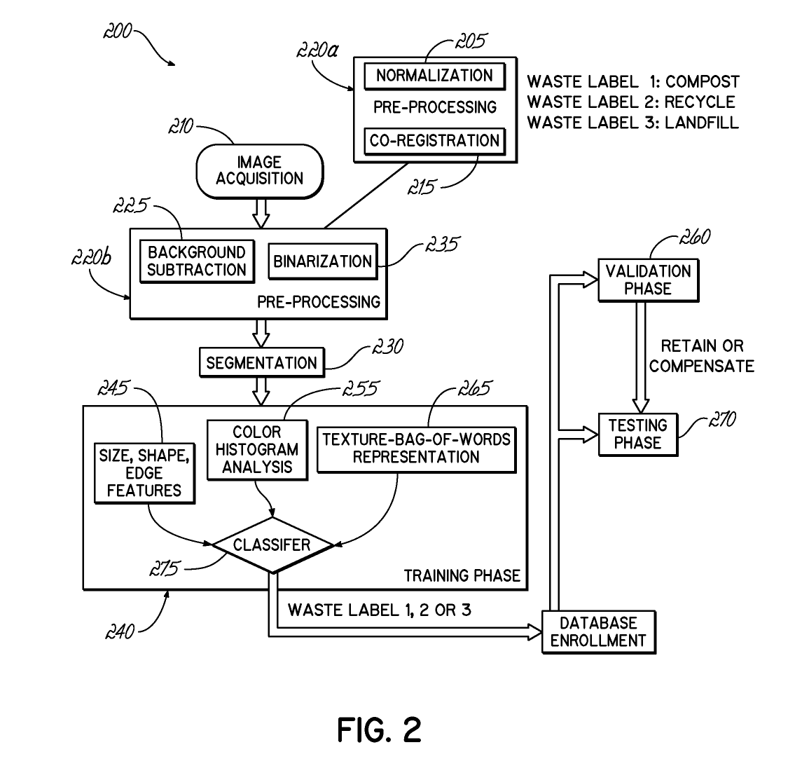

Embodiments consistent with the invention instruct a user as to an appropriate waste receptacle to discard a solid waste item into based on the identification of the solid waste item. One such implementation of instructing the user as to the appropriate solid waste receptacle to discard a solid waste item into, specifically in the application of capturing an image of the solid waste item to determine the appropriate solid waste receptacle to discard the solid waste item into, is illustrated by process 200 in FIG. 2. The solid waste item may also be identified via weight, density, color and/or any other identifying characteristic that may adequately identify the solid waste item that will be apparent to those skilled in the relevant art(s) without departing from the spirit and scope of the present disclosure.

Process 200 includes six primary steps: image acquisition 210, pre-processing 220a and 220b, segmentation 230, classification 240, validation phase 260, and a testing phase 270, each of which will be discussed in greater detail below. Steps 210-270 are typically implemented in a computer, e.g., via software and/or hardware, e.g., solid waste identification system 100 of FIG. 1.

A user may approach solid waste identification system 100 with the intention of disposing of solid waste items into solid waste receptacle 110a through 110n. Solid waste items are any discarded materials that are abandoned and/or considered waste-like. Solid waste items can include any type of solid, liquid, semi-solid and/or gaseous materials. The user may have several different solid waste items to discard. Each of the solid waste items may have a different recommended disposition method. For example, the user may have a banana peel to discard that has a recommended composting disposition method and also plastic silverware that has a recommended recycling disposition method. Solid waste identification system 100 may identify each solid waste item and instruct the user as to which solid waste receptacle 110a through 110n in which to properly dispose of each solid waste item.

In step 210, image detector system 120 may capture an image of the solid waste item prior to being discarded in a solid waste receptacle 110a through 110n. The user may place each solid waste item in a proximity to image detector module 120 prior to discarding each solid waste item into a solid waste receptacle 110a through 110n. The user may place each solid waste item in the proximity to image detector module 120 such that image detector module 120 may capture an adequate image of each solid waste item so that each solid waste item may be properly identified from each captured image.

The image detector module 120 may include a single modal camera system that includes a high resolution visual camera. The high resolution visual camera may be able to detect the feature aspects of the solid waste item so that the solid waste item may be accurately identified. However, specific solid waste items, such as liquids for example, may have feature aspects that are better identified by a forward-looking infrared imaging (FLIR) camera. For example, the FLIR camera may provide illumination invariance and provide greater detail when depicting each solid waste item with wide field of views than what is provided by the high resolution visual camera.

Thus, the image detector module 120 may include a multi-modal camera system with high resolution visual camera to capture visual images of the solid waste item and a forward-looking infrared imaging (FLIR) camera to capture FLIR images of the solid waste item. Data fusion between the data captured by the high resolution visual camera and the FLIR camera may improve the capabilities in capturing images of the solid waste item. The high resolution visual camera may capture data from the solid waste item based on light reflected off of the solid waste item back to the high resolution visual camera while the FLIR camera may capture data based on heat and light emission generated by the solid waste item.

The multi-modal camera system may improve the interactivity and robustness of the captured images but may also provide data from both the high resolution visual camera and the FLIR camera that complements each other. For example, the high resolution visual camera may capture details that the FLIR camera fails to capture and vice versa. Thus, the multi-modal camera system that includes the high resolution visual camera and the FLIR camera may increase the amount of data captured as compared to if a single camera is used.

As the user approaches solid waste identification system 100, first display 140 may notify the user to place each solid waste item into proximity of image detector module 120. For example, first display 140 may generate a recorded audio message to play that instructs the user to place each solid waste item into the proximity of image detector module 120. First display 140 may also notify the user to place the solid waste item into proximity of image detector module 120 when the user fails to place the solid waste item within proximity of image detector module 120.

After the images of the solid waste item have been captured by image detector module 120, in step 220a, pre-processing may be performed on the image by a processor 125 (e.g., a processor 125 integrated into image detector module 120 and implemented via a combination of hardware and software). For example, processor 125 may be a workstation processing device that includes a frame grabber card and an image processing software suite. Processor 125 may first perform normalization 205 to normalize the visual and the FLIR images. As noted above, the visual images and the FLIR images each capture the solid waste item. However, the visual images are distinct from the FLIR images so that each set of images include data unique to the imaging system that each set of images originated from. Thus, processor 125 may perform normalization 205 to normalize the visual images and the FLIR images to each other so that the data captured from each set of images may be properly analyzed relative to the solid waste item.

After processor 125 has performed normalization 205 in normalizing the visual images with the FLIR images, processor 125 may perform image co-registration 215 between the visual images and the FLIR images. Image co-registration 215 includes matching the features of the solid waste item captured by the visual images with the features of the solid waste item captured by the FLIR images so that the accuracy of the eventual classification of the solid waste item may be increased. Image co-registration 215 may enhance fusion of the data captured from the visual images and the FLIR images.

After processor 125 has performed image co-registration 215 of the visual images and the FLIR images, processor 125, in step 220b, may perform binarization 235 of the visual and the FLIR images to convert the visual and the FLIR images to binary images. A binary image is a digital image that has two possible values for each pixel. For example, each pixel may either be black or white. During binarization 235, each pixel may be classified as a black or white pixel based on the position of each pixel relative to the image in its entirety. For example, pixels positioned in the foreground of an image that are closer to the image detector module 120 may be classified as white pixels while the pixels positioned in the background of the image that are farther from the image detector module 120 may be classified as black pixels so that the background is distinct from the foreground. In another example, pixels positioned along the edges of the solid waste item captured by the image may be classified as black pixels while the pixels positioned away from the edges of the solid waste item may be classified as white pixels so that the edges of the solid waste item are distinct from the other portions of the image.

As noted above, processor 125 may perform binarization 235 to classify each pixel in the image as being part of the foreground or the background of the image so that the foreground may be distinct from the background. Processor 125 may then perform background subtraction 225 to remove the background from the images. For example, the background included in each image may have a high likelihood of including a food tray or a similar object in which the solid waste item is positioned while the solid waste item is positioned in the foreground. After binarization 235, the pixels positioned in the background that most likely depict the tray have a different value than the pixels positioned in the foreground that most likely depict the solid waste item. For example, the pixels positioned in the background depicting the tray may be classified as black pixels while the pixels positioned in the foreground depicting the solid waste item may be classified as white pixels. Processor 125 may then segment black pixels depicting the tray out of the image foreground so that only the white pixels depicting the solid waste item that is to be eventually classified remains in the processed images.

After processor 125 has subtracted the background from the images, in step 230, processor 125 may execute further segmentation of the processed images so that the processed images are segmented into different waste regions by employing various morphological operations, such as dilation and filling, to segment the images. Thus, a series of sub-images are further analyzed in the below steps to extract features of the solid waste item from the sub-images.

After processor 125 has pre-processed the images, in step 240, processor 125 may classify 275 the solid waste item into a solid waste item type based on the captured image of the solid waste item. The solid waste item type is associated with a recommended disposition method to dispose of the solid waste item. For example, solid waste identification system 100 may have the capabilities to dispose of each solid waste item via a landfill disposition method, a recycling disposition method, and/or a composting disposition method. Processor 125 may classify 275 the solid waste item into a solid waste item type that includes a landfill disposition method type, a recycling disposition method type, and/or a composting disposition method type.

Processor 125 may classify 275 the solid waste item based on the captured image of the solid waste item. Processor 125 may examine the captured image of the solid waste item and determine the solid waste item type. For example, processor 125 may examine the captured image of the banana peel and classify the banana peel as the composting disposition method type because the banana peel can be disposed of via composting.

In an embodiment, processor 125 may search a local or remote solid waste item database for a stored solid waste item image that is substantially similar to the image of the solid waste item. The solid waste item database may store a plurality of stored solid waste item images. Each stored solid waste item image stored in the solid waste item database may be an image of a solid waste item. Solid waste item database may also store a solid waste item type that is associated with each stored solid waste item image. For example, solid waste item database stores an image of a banana peel. Solid waste item database also stores a solid waste item type that includes the composting disposition method type associated with the stored image of the banana peel.

Processor 125 may search the solid waste item database for stored solid waste item images that may be substantially similar to the captured image. After finding the stored solid waste item image that is substantially similar to the captured image, processor 125 pulls the solid waste item type associated with the stored solid waste item image in the solid waste item database. Processor 125 then classifies the solid waste item with the solid waste item type provided by the solid waste item database for the stored solid waste item image that is substantially similar to the captured image.

For example, processor 125 searches the solid waste item database for a stored image that is substantially similar to the captured image of a banana peel. Processor 125 then pulls the solid waste item type from the solid waste item database that is associated with the stored image of the banana peel. The solid waste item type that is associated with the stored image of the banana peel is the composting disposition method type. Processor 125 then classifies the banana peel with the composting disposition method type.

In an embodiment, processor 125 may classify 275 the solid waste item into the solid waste item type that is associated with a landfill disposition method, a recycling disposition method, or a composting disposition method. Processor 125 may default to and classify the solid waste item into the landfill disposition method when processor 125 cannot find a stored solid waste item image that is substantially similar to the captured image in the solid waste item database.

Processor 125 may examine each sub-image previously generated by processor 125 from the visual and FLIR images to identify features of the solid waste item that the processor 125 may then use to classify 275 the solid waste item. Processor 125 may extract features 245 from each sub-image that include but are not limited to the size, shape, edge, texture, color-based features, codes and/or any other feature associated with the solid waste item that processor 125 may use to classify 275 the solid waste item that will be apparent to those skilled in the relevant art(s) without departing from the spirit and scope of the present disclosure. In an embodiment, processor 125 may extract the features 245 from each sub-image using a bag-of-words (BoW) technique 265. The BoW technique 265 may treat the extracted features 245 as independent variables that are collectively represented using a histogram 255. The BoW technique 265 may mix and match the extracted features 245 from each sub-image to incorporate an optimal feature set to be used in classifying 275 the solid waste item. The feature selection may be based on pattern recognition stochastic variable selection methods.

Processor 125 may incorporate a training phase into the classifying 275 of solid waste items by processor 125. Processor 125 may build the solid waste item database with features that have been previously extracted from solid waste items and used to successfully classify 275 each solid waste item. Thus, processor 125 may continually customize the solid waste item database with features of solid waste items that are typical for the environment that processor 125 is located. For example, solid waste identification system 100 is located in a high school cafeteria. Processor 125 may customize the solid waste item database to include features from solid waste items typically identified by processor 125. In such an example, processor 125 customizes the solid waste item database to include features that are typically associated with pint sized milk cartons. Such a customization performed by processor 125 may assist processor in identifying typical waste items when placed in different orientations. For example, processor 125 may easily identify the pint sized milk carton when the pint sized milk carton is placed upright and on when it is placed on its side.

Processor 125 may implement a neural network in customizing the solid waste item database. The neural network is a trainable system that may be employed to classify 275 the solid waste item into the landfill, recyclable, and compostable classification options. The neural network adds flexibility to processor 125 so that processor 125 may be trained for the specific environment and/or industry that processor 125 is located. Solid waste identification system 100 may begin with the solid waste item database that includes a base of known features associated with known solid waste items. However, the neural network may enable processor 125 to continually grow the solid waste item database with additional features associated with either known solid waste items or previously unknown solid waste items that processor 125 has successfully classified 275. Thus, the neural network may enable processor 125 to accommodate for rotational, structural, and/or color variations for solid waste items that differ from the features previously stored in the solid waste item database.

In step 260, a validation data set may be generated to minimize over fitting. The validation data set may verify that any increase in accuracy over the training data set yields an increase in accuracy over the validation data set.

In step 270, a testing set may be generated as an independent unseen data set by the neural network that may be used to confirm the predictive capabilities of the neural network. Under certain conditions, the neural network may not identify the solid waste item. In such a case, the neural network may be trained to classify the unidentified solid waste item into the landfill category. The landfill disposition method may properly encompass all solid waste items. Although a solid waste item may be recyclable and/or compostable, such solid waste items may be properly disposed of by the landfill disposition method despite being recyclable and/or compostable. However, a solid waste item that may be recyclable but not compostable cannot be properly disposed of via the composition disposition method because the composition disposition method cannot effectively dispose of solid waste items that are not compostable.

After the solid waste item has been classified, the user may be instructed to discard the solid waste item into the appropriate solid waste receptacle 110a through 110n. The appropriate solid waste receptacle 110a through 110n is designated based on the recommended disposition method for the solid waste item. The recommended disposition method for the solid waste item may include the disposition method that may provide a most favorable impact on the environment relative to the other disposition methods.

For example, a banana peel is capable of being disposed of via the composting disposition method because the banana peel decomposes into compost. Instructing the user to discard the solid waste item into the composting solid waste receptacle has the most favorable impact on the environment as compared to the recycling disposition method and/or the landfill disposition method. The banana peel is not recyclable and thus cannot be disposed of via the recycling disposition method. The banana peel can be disposed of via the landfill disposition method. However, disposing the banana peel via the landfill disposition method is not as favorable to the environment as disposing the banana peel via the composting disposition method. Thus, processor 125 instructs the user to dispose of the banana peel into the compost solid waste receptacle 110n.

The appropriate solid waste receptacle 110a through 110n in which to discard the solid waste item may be displayed to the user via first display 140. First display 140 may display the appropriate solid waste receptacle 110a through 110n in which to discard each solid waste item in that first display 140 may display a running list of each appropriate solid waste receptacle 110a through 110n corresponding to each solid waste item. For example, first display 140 may display that compost solid waste receptacle 110n is the appropriate receptacle for the user to discard the banana peel and also display that recycling solid waste receptacle 110b is the appropriate receptacle for plastic silverware. First display 140 may also display a color that coordinates to a color associated with the appropriate solid waste receptacle 110a through 110n. For example, first display may display the color red when displaying that compost solid waste receptacle 110n is the appropriate receptacle for the user to discard the banana peel. In such an example, compost solid waste receptacle 110n may also be the color red to coordinate with the color red of first display 140 displaying that compost solid waste receptacle 110n is the appropriate solid waste receptacle to dispose of the banana peel. The second display 130 may display to the user an advertisement designated by a solid waste facility associated with solid waste identification system 100. First display 140 and second display 130 may include a touchscreen and/or keypad configuration.

Processor 125 may also instruct the user as to the appropriate receptacle 110a through 110n to discard the solid waste item by wirelessly communicating this information to the user. For example, processor 125 may communicate this information to the user by sending a text message to the user's wireless communications device. In another example, processor 125 may communicate this information to the user via a mobile application downloaded on the user's wireless communications device.

Processor 125 may also instruct the user as to the appropriate solid waste receptacle 110a through 110n to discard the solid waste item by having the appropriate solid waste receptacle 110a through 110n light up based on the classification of the solid waste item. For example, processor 125 may control the compost solid waste receptacle 110n to light up after the banana peel has been classified as being disposed of via the compost disposition method. The user may then easily identify compost solid waste receptacle 110n as the appropriate solid waste receptacle 110a through 110n in which to dispose of the banana peel based on the lighting up of compost solid waste receptacle 110n.

Processor 125 may also control each lid of each corresponding solid waste receptacle 110a through 110n based on the classification of the solid waste item. Processor 125 may lock each lid for each solid waste receptacle 110a through 110n so that the user cannot improperly dispose of the solid waste item into an inappropriate solid waste item receptacle 110a through 110n. Rather, processor 125 may unlock and/or open the lid of the appropriate solid waste item receptacle 110a through 110n for the user to properly dispose of the solid waste receptacle. For example, processor 125 may lock each lid for each solid waste item receptacle 110a through 110n until the banana peel is classified as to be disposed of via the compost disposition method. Processor 125 may then unlock and/or open the lid of compost solid waste receptacle 110n while continuing to have the lids of landfill solid waste receptacle 110a and recycling solid waste receptacle 110b locked. The user may then dispose of the banana peel into the opened lid of compost solid waste receptacle 110n without having the opportunity to incorrectly dispose of the banana peel in landfill solid waste receptacle 110a and/or recycling solid waste receptacle 110b due to the lids of each remaining locked.

In an embodiment, solid waste identification system 100 may be modified to remove image detector module 120 so that the classification capabilities of solid waste identification system 100 are no longer functional. In such an embodiment, processor 125 may control the lids of each solid waste receptacle 110a through 110n as discussed in detail above. Processor 125 may lock each lid for solid waste receptacles 110a through 110n. Processor 125 may detect when the user is within proximity of solid waste identification system 100 so that user is in position to discard a solid waste item into one of solid waste receptacles 110a through 110n. Processor 125 may continue to maintain each lid for each solid waste receptacle 110a through 110n in a locked state so that the user cannot easily discard the solid waste item into an inappropriate solid waste receptacle 110a through 110n.

Second display 130 may then display to the user information to educate to the user the types of solid waste items that are to be properly discarded into each of solid waste receptacles 110a through 110n. Second display 130 may include one or more touch screens that may display a digital catalog for the user to search for the appropriate solid waste receptacle 110a through 110n to dispose of the solid waste item. The user may search through the digital catalog displayed using the touch screens to scroll through the digital catalog in search of the solid waste item and the corresponding recommended disposition method for the solid waste item. For example, the user scrolls through the digital catalog via the touch screens for a designation of a banana peel. The digital catalog displays that the corresponding recommended disposition method for the banana peel is compost solid waste receptacle 110n. The user may then determine based on the recommendation that compost solid waste receptacle 110n is the appropriate disposition method for the banana peel. After the user has made such a decision, the user may acknowledge via the touch screens of second display 130 that the user confirms that compost solid waste receptacle 110n is the appropriate disposition method and then unlock the lid of solid waste item receptacle 110n to discard the banana peel. The user may unlock the lid of the appropriate solid waste item receptacle 110a through 110n by waving a hand within proximity of a sensor coupled to the appropriate solid waste item receptacle 110a through 110n so that processor 125 then opens the lid of the appropriate solid waste item receptacle 110a through 110n, by pushing a button, touching a touch screen or keypad, eye sensors and/or any other acknowledgement method that the user has determined the appropriate solid waste item receptacle 110a through 110n to discard the solid waste item that will be apparent to those skilled in the relevant arts) without departing from the spirit and scope of the present disclosure.

The locking of each lid for solid waste item receptacles 110a through 110n until the user has made an educated decision as to which solid waste item receptacle 110a through 110n to discard the solid waste item into provides a restraint that encourages the user to take a moment to decide which solid waste receptacle 110a through 110n to discard the solid waste item. For example, the user has the banana peel to discard. Processor 125 maintains each solid waste receptacle 110a through 110n in a locked state. After reading the information provided by second display 130 that states that perishable food items such as banana peels should be disposed of in compost solid waste receptacle 110n, the user makes a decision that the banana peel should be disposed in compost solid waste receptacle 110n. The user then unlocks the lid for compost solid waste receptacle 110n and disposes the banana peel in compost solid waste receptacle 110n while processor 125 maintains the lids for landfill solid waste receptacle 110a and recyclable solid waste receptacle 110b in a locked state. The maintaining of the lids for landfill solid waste receptacle 110a and recyclable solid waste receptacle 110b in the locked state prevents the user form easily discarding the banana peel in an inappropriate solid waste receptacle 110a through 110n. Solid waste item data may be recorded in the solid waste item database that is associated with each solid waste item that is discarded into solid waste receptacles 110a through 110n. The solid waste item data may provide informative data regarding each solid waste item. The solid waste item data may be incorporated into a solid waste item metric to inform the solid waste item facility associated with solid waste identification system 100 of the solid waste items discarded into each solid waste receptacle 110a through 110n. The solid waste item metric may be reported to a facility maintenance team and/or the solid waste item facility. The facility maintenance team may add and/or remove solid waste item data from the solid waste item database.

For example, a hospital may utilize solid waste identification system 100. The hospital may receive reports that include solid waste item metrics related to the quantity of solid waste items discarded into each solid waste receptacle 110a through 110n. The solid waste item data incorporated into the solid waste item metrics provide the solid waste item type for each solid waste item. In such an example, the quantity of solid waste items classified as the landfill disposition method type are reported to the hospital, the solid waste items classified as the recycling disposition method type are reported to the hospital, and the solid waste items classified as the composting disposition method type are reported to the hospital.

The solid waste item database may be customized to include stored solid waste images that are associated with solid waste items used at the solid waste item facility. The solid waste item database may be customized to include solid waste types associated with each corresponding solid waste item based on the solid waste receptacles 110a through 110n located at the solid waste distribution facility. For example, the solid waste item database may be customized to include stored solid waste images that include a biodegradable coffee cup that the hospital distributes to individuals to use. The solid waste image database may also be customized to include a solid waste type that includes the composting disposition method type because the hospital includes the compost solid waste receptacle 110n.

In an embodiment, each solid waste receptacle 110a through 110n is associated with a different disposition method to dispose of each solid waste type. As noted above, solid waste identification system 100 includes landfill waste receptacle 110a, recycling waste receptacle 110b, and composting waste receptacle 110c.

A customized solid waste receptacle liner may be assigned to each solid waste receptacle based on the disposition method associated with each solid waste receptacle 110a through 110n. Each customized solid waste liner is disposed with each solid waste item discarded into each customized solid waste liner. For example, the solid waste item liner that is included in compost solid waste receptacle 110n is made of a material that is also capable of being disposed of via the composting disposition method. Thus, the solid waste items included in the solid waste item liner for compost solid waste receptacle 110n do not have to be removed from the solid waste liner before initiating the compost disposition method for the solid waste items.

In an embodiment, solid waste identification system 100 may be portable in that solid waste identification system 100 may be moved from a first location to a second location. Solid waste identification system 100 may include a plurality of wheels so that solid waste identification system 100 may be moved from the first location to the second location. Each solid waste receptacle 110a through 110n may also be portable. Each solid waste receptacle 110a through 110n may be removed from solid waste identification system 100 and moved from the first location to the second location.

Solid waste identification system 100 may include a Radio Frequency Identification (RFID) tag. The RFID tag may be assigned to solid waste identification system 100 so that a location of solid waste identification system 100 may be tracked. Further, each solid waste receptacle 110a through 110n may also include an RFID tag. The RFID tag may be assigned to each solid waste receptacle 110a through 110n so that a location of each solid waste receptacle 110a through 110n may be tracked.

Solid waste identification system 100 may also include a rewards program to reward users for successfully disposing solid waste items into the appropriate solid waste receptacle 110a through 110n. After the user has successfully disposed the solid waste item into the appropriate solid waste receptacle 110a through 110n, processor 125 may generate reward points, coupons, prizes, and/or any other incentive to urge the user to discard the solid waste item into the appropriate solid waste receptacle 110a through 110n that will be apparent to those skilled in the relevant art(s) without departing from the spirit and scope of the present disclosure. Solid waste identification system 100 may also include a badge reader so that the user may swipe their badge through the badge reader after successfully discarding the solid waste item into the appropriate solid waste receptacle 110a through 110n. Processor 125 may then provide points, coupons, prizes, etc. to the badge of the user to reward the user for successfully discarding the solid waste item into the appropriate solid waste receptacle 110a through 110n.

Solid waste identification system 100 may also include a compactor or crusher within each solid waste receptacle 110a through 110n so that each solid waste item disposed into each solid waste receptacle 110a through 110n may be compacted and/or crushed. Solid waste identification system 100 may also include a liquid segregator within each solid waste receptacle 110a through 110n so that left over liquid from each solid waste item may be segregated from the solid portions of each solid waste item. Segregating the left over liquid from each solid waste item may reduce the size of the trash that accumulates in each solid waste receptacle 110a through 110n to minimize the load size of the trash to be hauled away from solid waste identification system 100 that in turn lowers trash hauling expenses.

### Automatic Binning of Solid Waste Items

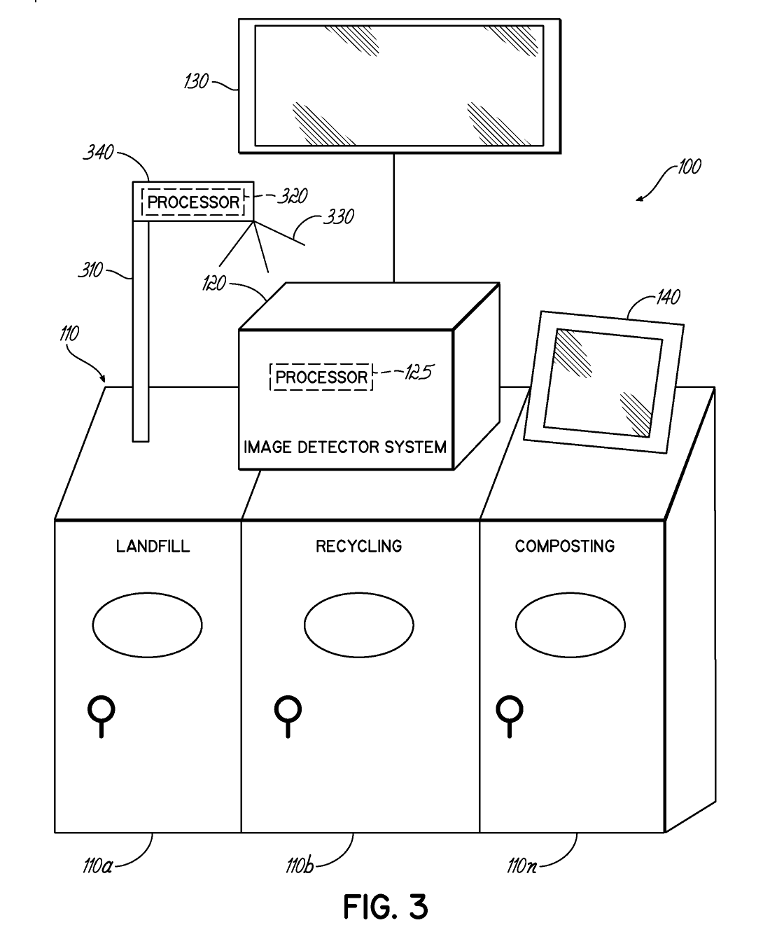

Turning now to FIG. 3, this figure illustrates a solid waste identification system 300 where a solid waste item is identified and then the solid waste item is automatically placed by solid waste identification system 300 in the appropriate solid waste receptacle in which to dispose of the solid waste item. Solid waste identification system 300 includes solid waste receptacle configuration 110, image detector module 120, first display 140, second display 130 and a robotic arm 310. Solid waste receptacle configuration 110 includes first solid waste receptacle 110a, second solid waste receptacle 110b, and third solid waste receptacle 110n where n is an integer greater than or equal to 1. Robotic arm 310 includes a processor 320 and a sensor system 340.

Rather than instructing the user as to which solid waste receptacle 110a through 110n to discard the solid waste item based on the classification of the solid waste item, robotic arm 310 may be instructed as to which solid waste receptacle 110a through 110n to discard the solid waste item. Robotic arm 310 may then grasp the solid waste item and place the solid waste item in the appropriate solid waste receptacle 110a through 110n. The automatic binning of the solid waste item performed by the robotic arm 310 relieves the user of any responsibility in properly discarding the solid waste item into the appropriate solid waste receptacle 110a through 110n. Thus, the user may have limited opportunity to discard the solid waste item into an inappropriate solid waste receptacle.

After the solid waste item has been classified by processor 125 as discussed in detail above, processor 320 (e.g., a processor 320 integrated into robotic arm 310 and implemented via a combination of hardware and software) may receive a request from processor 125 to transfer the solid waste item from an existing position to the appropriate solid waste receptacle 110a through 110n. As discussed in detail above, processor 125 has already determined the appropriate solid waste receptacle 110a through 110n for discarding the solid waste item. Rather than instructing the user to manually place the solid waste item into the appropriate solid waste receptacle 110a through 110n, processor 125 may instruct processor 320 of the appropriate solid waste receptacle 110a through 110n to discard the solid waste item. Processor 320 may then determine an existing position of the solid waste item. The existing position of the solid waste item is the current position of the solid waste item on solid waste identification system 300. Processor 320 may then instruct the robotic arm to move the solid waste item from the existing position of the solid waste item to the appropriate solid waste receptacle 110a through 110n.

Processor 320 may determine a space that defines a maximum radius from an initial position 330 of robotic arm 310 that the solid waste item can be located for the robotic arm to reach the solid waste item and transfer the solid waste item from the existing position of the solid waste item to the appropriate solid waste receptacle 110a through 110n. Initial position 330 of robotic arm 310 is the rest position of robotic arm 310 where robotic arm 310 returns to after discarding the solid waste item in the appropriate solid waste receptacle 110a through 110n. Thus, initial position 330 is also the position of robotic arm 310 when processor 320 receives the request from processor 125 to discard the solid waste item into the appropriate solid waste receptacle 110a through 110n.

The space is the three-dimension extent that is bounded by the radius of the maximum reach of robotic arm 310 and incorporates initial position 330 of robotic arm 310, the existing position of the solid waste item, and the positions of solid waste receptacles 110a through 110n relative to solid waste identification system 300. The radius of the maximum reach of robotic arm 310 is the physical limitation of robotic arm 310 that limits the reach of robotic arm 310. Any solid waste item positioned beyond the radius of the maximum reach of robotic arm 310 may not be included in the space determined by processor 320. Processor 320 may determine the space so that processor 320 may then determine the location of the existing position of the solid waste item relative to initial position 330 of robotic arm 310 and solid waste item receptacles 110a through 110n.

Processor 320 may determine a set of coordinates that designate the location of the existing position of the solid waste item in the space. The set of coordinates may be relative to initial position 330 of robotic arm 310. Processor 320 may also determine the orientation of the solid waste item in space. The orientation of the solid waste item may also be relative to initial position 330 of robotic arm 310. For example, the solid waste item is a 20 oz. plastic bottle. The existing position of the plastic bottle is inside image capturing module 120 and the plastic bottle is oriented on its side rather than standing upright. Processor 320 determines the (x, y, z) coordinates of the existing position of the plastic bottle inside capturing module 120. The (x, y, z) coordinates determined by processor 320 are in the space determined by processor 320 and are relative to initial position 330 of robotic arm 310. Processor 320 also determines that the plastic bottle is oriented on its side. The side orientation determined by processor 320 is also relative to initial position 330 of robotic arm 310.

Processor 320 may also determine a set of coordinates for a location of the appropriate solid waste receptacle 110a through 110n in the space so that the set of coordinates is also relative to initial position 330 of robotic arm 310. The existing position of the solid waste item may change for each solid waste item that robotic arm 310 is instructed to move to the appropriate solid waste receptacle 110a through 110n. As a result, processor 320 dynamically determines the location of the solid waste item after receiving the request from processor 125 to discard the solid waste item in the appropriate solid waste receptacle 110a through 110n. However, the location of each solid waste receptacle 110a through 110n may not change but rather remain substantially stable each time processor 320 is requested to discard a solid waste item. As a result, processor 320 may have determined a priori the set of coordinates for each solid waste receptacle 110a through 110n.

For example, processor 125 may recognize that the solid waste item is a 20 oz. plastic bottle and classify the solid waste item as recyclable. Processor 125 may then request that processor 320 instruct robotic arm 310 to dispose of the 20 oz. plastic bottle in solid waste receptacle 110b so that the 20 oz. plastic bottle is recycled. Processor 320 already has determined a priori the (x, y, z) coordinates of an opening for solid waste receptacle 110b in the space so that the (x, y, z) coordinates of the opening for solid waste receptacle 110b is relative to initial position 330 of robotic arm 310. After instructing robotic arm 310 to grasp the 20 oz. plastic bottle, processor 320 may then instruct robotic arm 310 to move to the (x, y, z) coordinates of the opening for solid waste receptacle 110b and discard the 20 oz. plastic bottle in solid waste receptacle 110b.

Often times, the user may have several solid waste items to discard. For example, solid waste identification system 300 may be located in a high school cafeteria where the user has eaten lunch and has several solid waste items located on the user's tray that are to be discarded. The user may place the tray with the solid waste items positioned on it inside image capturing module 120. Image capturing module 120 may capture images that adequately depict each solid waste item. Processor 125 may then classify each solid waste item based on the images captured by image capturing module 120 as discussed in detail above. After processor 125 has classified each solid waste item, processor 125 may then request processor 320 to instruct robotic arm 310 to place each solid waste item in the appropriate solid waste receptacle 110a through 110n as determined by processor 125. Rather than having a single solid waste item for processor 320 to determine the existing position of and then instruct robotic arm 310 to grasp and move the solid waste item, processor 320 has several solid waste items to engage.

Processor 320 may segregate a single solid waste item from the several solid waste items positioned within the space. In segregating a single solid waste item, processor 320 focuses on a single solid waste item and ignores the remaining solid waste items. Processor 320 may select a first solid waste item to segregate from the remaining solid waste items. Processor 320 may determine the appropriate solid waste receptacle 110a through 110n to discard the first solid waste item based on the instructions received from processor 125 that previously classified the first solid waste item. Processor 320 may then determine the set of coordinates and the orientation of the first solid waste item while ignoring each of the remaining solid waste items. Processor 320 may then instruct robotic arm 310 to grasp the first solid waste item and discard the first solid waste item in the appropriate solid waste receptacle 110a through 110n. After robotic arm 310 has successfully discarded the first solid waste item and has returned back to initial position 330, processor 320 may then segregate a second solid waste item from the remaining solid waste items and execute the process of discarding the second solid waste item in the appropriate solid waste receptacle 110a through 110n. Processor 320 may continue to segregate each remaining solid waste item until each solid waste item has been properly discarded in its respective appropriate solid waste receptacle 110a through 110n.

In an embodiment, robotic arm 310 may include a sensor system 340 that captures data from the solid waste item. Sensor system 340 may include one or more sensors that may be a video imaging system, an infrared imaging system, a photographic imaging system, an air sensing system, a thermal sensing system, a motion sensor that is capable of capturing three-dimensional data such as a Kinect motion sensing input device by Microsoft, a volumetric sensor that is capable of capturing three-dimensional data such as a Leap Motion sensing input device by Leap Motion, and/or any other type of sensors that will be apparent to those skilled in the relevant art(s) without departing from the spirit and scope of the present disclosure.

As noted above, processor 125 may request processor 320 to instruct robotic arm to discard the solid waste item into the appropriate solid waste receptacle 110a through 110n based on the classification of the solid waste item performed by processor 125. Processor 320 may then instruct sensor system 340 to project an infrared laser pattern onto the solid waste item. Sensor system 340 may then recognize the laser pattern and may capture infrared information from the solid waste item. The infrared information may be partitioned by sensor system 340 into pixels where each pixel provides infrared information for a portion of the solid waste item that is associated with each pixel. For example, sensor system 340 may determine the distance of each pixel (portion of the solid waste item) from sensor system 340.

Sensor system 340 may also include a red-green-blue (RGB) camera that captures an RGB image of the solid waste item. The distance of each pixel determined by sensor system 340 may be mapped onto the RGB image of the solid waste item, thus generating a RGB depth (RGBD) image where each mapped pixel has both a color and a distance associated with it. Processor 320 may then determine the set of coordinates and the orientation of solid waste item based on the information provided by the RGBD image of the solid waste item and may then proceed with instructing robotic arm 310 to discard the solid waste item in the appropriate solid waste receptacle 110a through 110n.

Sensor system 340 may also project an infrared laser pattern onto each solid waste item when several solid waste items are located within the space determined by processor 320. Sensor system 340 may then capture infrared information from each of the solid waste items. Sensor system 340 may partition the infrared information into pixels that are associated with a portion of each solid waste item. Sensor system 340 may also capture an RGB image that captures each of the solid waste items. Sensor system 340 may then map the distance of each pixel onto the RGB image to generate the RGBD image of each solid waste item. Processor 320 may then determine which solid waste item to segregate from the RGBD image of the several solid waste items. Processor 320 may then determine the set of coordinates of the segregated solid waste item from the RGBD image and may then proceed to instruct robotic arm 310 to discard the segregated solid waste item in the appropriate solid waste receptacle 110a through 110n.

Robotic arm 310 may be a HP3C Motoman robot with a gripper and may have at least six degrees of freedom for complete dexterity in terms of position and orientation of the solid waste item being moved. Each joint included in robotic arm 310 may be actuated by a dynamixel servo motor which includes built-in controls for controlling position and velocity. The dynamixel servo motors may be precise, sturdy, and have a low profile for their capabilities. Such features are desirable to perform smooth, real-time operations for robotic arm 310. The gripper of robotic arm 310 may have two or three fingers that may be actuated by another dynamixel servo motor. The gripper of robotic arm 310 may also include a suction cup. Each of the dynamixel servo motors may be wired in a serial chain thereby avoiding cable clusters and snaps during operation. Each of the dynamixel servo motors may communicate with processor 320 through Recommended Standard (RS) 485 protocol.

The six degrees of freedom may provide complete dexterity within the space determined for robotic arm 310. A modular design of the links may allow for modifications to the space determined for robotic arm 310. The cost of robotic arm 310 may be significantly lower than other commercial off the shelf robotic arms. The software used to control robotic arm 310 may be open source to allow complete control over various aspects of robotic arm 310 unlike commercial off the shelf robots that limit the control users have over the robotic arm.

Solid waste identification system 300 may also include a conveyor belt. Trays including solid waste items may be placed on the conveyor belt and/or solid waste items may be directly placed on the conveyor belt. The conveyor belt may extend into image capturing module 120 so that each of the solid waste items may be captured by image capturing module 120. Robotic arm 310 may then discard each solid waste item that is positioned on the conveyor belt into each appropriate solid waste receptacle 110a through 110n.

### CONCLUSION

The foregoing description of the specific embodiments will so fully reveal the general nature of the present invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not limitation, such that the terminology or phraseology of the specification is to be interpreted by the skilled artisan in light of the teachings and guidance.

Therefore, embodiments consistent with the invention may be used to provide a system of instructing a user as to an appropriate solid waste receptacle to discard a solid waste item into based on an identification of the solid waste item. In many embodiments, this may permit the user from inadvertently discarding the solid waste item into an inappropriate solid waste receptacle.

The breadth and scope of the present invention should not be limited by any of the above-described exemplary embodiments, but should be defined only in accordance with the claims and their equivalents.

1. A system, comprising:
an image detection system configured to capture an image of the solid waste item prior to being discarded in a solid waste receptacle;
at least one processor; and
program code configured for execution by the at least one processor to:
classify the solid waste item into a solid waste item type based on the captured image of the solid waste item, wherein the solid waste item type is associated with a recommended disposition method to dispose of the solid waste item, and
instruct the user to discard the solid waste item into the appropriate solid waste receptacle based on the solid waste item type of the solid waste item, wherein the appropriate solid waste receptacle is designated based on the recommended disposition method of the solid waste item.

2. The system of claim 1, wherein the program code is further configured to:
search a solid waste item database for a stored solid waste item image that is substantially similar to the image of the solid waste item; and
classify the solid waste item into a solid waste item type based on the solid waste item type associated with the stored solid waste item image that is substantially similar to the image of the solid waste item.

3. The system of claim 1, wherein the program code is further configured to:
display to the user on a first display the appropriate receptacle to discard the solid waste item based on the solid waste item type of the solid waste item; and
display to the user on a second display an advertisement designated by a solid waste facility associated with the appropriate solid waste receptacle.

4. (canceled)

5. The system of claim 1, wherein the program code is further configured to:
record in the solid waste item database solid waste item data associated with each solid waste item from a plurality of solid waste items discarded into the appropriate receptacle, wherein the solid waste item data provides informative data regarding the plurality of solid waste items;
incorporate the solid waste item data into a solid waste item metric to inform the solid waste item facility associated with the appropriate solid waste receptacle of the solid waste items discarded in the appropriate solid waste receptacle; and
report the solid waste item metric to the solid waste item facility.

6. The system of claim 5, wherein the program code is further configured to record in the solid waste item database the solid waste item type classified for the solid waste item.

7. The system of claim 5, wherein the program code is further configured to record the solid waste item type into a solid waste item type metric to inform the solid waste item facility associated with the appropriate receptacle of the solid waste item type that the solid waste item that was classified as.

8. (canceled)

9. The system of claim 1, wherein the program code is further configured to:
notify the user to place the solid waste item into the image detection system when the user approaches the image detection system, and
notify the user to place the solid waste item into the image detection system when the user fails to place the solid waste item into the image detection system.

10. The system of claim 9, wherein the program code is further configured to:
enable the user to unlock a lid to the appropriate solid waste receptacle when the user acknowledges that the solid waste item should be discarded in the appropriate solid waste receptacle.

11. (canceled)

12. The system of claim 1, wherein the program code is further configured to:
customize the solid waste item database configured to include a plurality of stored solid waste images that is associated with a plurality of solid waste items used at the solid waste item facility that distributes the plurality of solid waste items to a plurality of users; and
customize the solid waste item database to include a plurality of solid waste types with each solid waste type associated to each corresponding solid waste item based on a plurality of solid waste receptacles located at the solid waste distribution facility, wherein the solid waste item database is customized with the plurality of solid waste types based on the plurality of solid waste receptacles available at the solid waste distribution facility.

13-16. (canceled)

17. The system of claim 12, wherein the program code is further configured to classify the solid waste item into the solid waste item type that is associated with the landfill disposition method when the program code fails to classify the solid waste item into the solid waste item type.

18-23. (canceled)

24. A method of instructing a user as to an appropriate solid waste receptacle to discard a solid waste item into based on an identification of the solid waste item, comprising:
capturing an image of the solid waste item prior to being discarded in a solid waste receptacle;
classifying the solid waste item into a solid waste item type based on the captured image of the solid waste item, wherein the solid waste time type is associated with a recommended disposition method to dispose of the solid waste item; and
instructing the user to discard of the solid waste item into the appropriate solid waste receptacle based on the solid waste item type of the solid waste item, wherein the appropriate solid waste receptacle is designated based on the recommended disposition method of the solid waste item.

25. The method of claim 24, wherein the classifying comprises:
search a solid waste item database for a stored solid waste item image that is substantially similar to the image of the solid waste item; and
classify the solid waste item into a solid waste time type based on the solid waste item type associated with the stored solid waste item image that is substantially similar to the image of the solid waste item.

26. The method of claim 24, wherein the instructing comprises:
displaying to the user on a first display the appropriate receptacle to discard the solid waste item based on the solid waste item type of the solid waste item; and
displaying to the user on a second display an advertisement or data designated by a facility associated with the appropriate solid waste receptacle.

27. The method of claim 24, further comprising:
recording in the solid waste item database solid waste item data associated with each solid waste item from a plurality of solid waste items discarded into the appropriate receptacle, wherein the solid waste item data provides informative data regarding the plurality of solid waste items;
incorporating the solid waste item data into a solid waste item metric to inform the solid waste item facility associated with the appropriate solid waste receptacle of the plurality of solid waste items discarded in the appropriate solid waste receptacle; and
reporting the solid waste item metric to a facility maintenance team or the solid waste item facility.

28. The method of claim 27, further comprising:
recording in the solid waste item database the solid waste item type classified for the solid waste item;
incorporating the recorded solid waste item type into a solid waste item type metric to inform the solid waste item facility associated with the appropriate receptacle of the solid waste item that was classified to be discarded into the appropriate solid waste receptacle; and
reporting the solid waste item type metric to the solid waste item facility.

29. The method of claim 24, further comprising:
notifying the user to place the solid waste item into the image detection system when the user approaches the image detection system; and
notifying the user to place the solid waste item into the image detection system when the user fails to place the solid waste item into the image detection system.

30. The method of claim 24, further comprising:
customizing the solid waste item database to include a plurality of stored solid waste images that is associated with a plurality of solid waste items used at the solid waste item facility that distributes the plurality of solid waste items to a plurality of users; and
customizing the solid waste item database to include a plurality of solid waste types with each solid waste type associated to each corresponding solid waste item based on a plurality of solid waste receptacles located at the solid waste distribution facility, wherein the solid waste item database is customized with the plurality of solid waste types based on the plurality of solid waste receptacles available at the solid waste distribution facility.

31. The method of claim 30, wherein each solid waste receptacle is associated with a different disposition method to dispose of each solid waste type discarded into each solid waste receptacle.

32. The method of claim 31, further comprising:
assigning a customized solid waste receptacle liner to each solid waste receptacle based on the disposition method associated with each solid waste receptacle, wherein each customized solid waste liner is disposed with each solid waste item discarded into each customized solid waste liner.

33-34. (canceled)

35. The method of claim 28 wherein the classifying further comprises:
classifying the solid waste item into the solid waste item type that is associated with the landfill disposition method when the classifying fails to classify the solid waste item into the solid waste item type.

36-55. (canceled)
